(19) United States
(12) Patent Application Publication
(10) Pub. No.: US 2007/0091928 A1
(43) Pub. Date: Apr. 26, 2007

(54) Serial and parallel processing of data using information about the data and information about a streaming network

(76) Inventors: Susie J. Wee, Palo Alto, CA (US); John G. Apostolpoulos, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/256,565

(22) Filed: Oct. 21, 2005

(51) Int. Cl. H04J 3/24

(52) U.S. Cl. 370/474; 370/252

(57) ABSTRACT

Methods and systems thereof for processing data are described. Data in a plurality of data packets is accessed. The data is separated into a plurality of data portions. The data portions are sent to respective nodes in a network, wherein the nodes process (e.g., transcode) the data in parallel with each other.

### CROSS REFERENCES TO RELATED APPLICATIONS

This Application is related to the co-pending, commonly-owned U.S. patent application Ser. No., Attorney Docket No. HP-200401902-1, Ser. No. ______, filed ______,by S. Wee et al., entitled “Serial Processing of Data Using Information About the Data and Information About a Streaming Network,” and hereby incorporated by reference in its entirety.

This Application is related to the co-pending, commonly-owned U.S. patent application Ser. No., Attorney Docket No. HP-200405065-1, Ser. No. ______, filed ______, by S. Wee et al., entitled “Parallel Processing of Data Using Information About the Data and Information About a Streaming Network,” and hereby incorporated by reference in its entirety.

### TECHNICAL FIELD

Embodiments of the present invention relate to the field of streaming media data.

### BACKGROUND

Media streaming and communications continue to gain in importance. Adapting the media to accommodate diverse client capabilities and heterogeneous and time-varying communication links is one of the keys to efficient and effective media streaming. For example, clients can have different display, communication, power and computational capabilities. In addition, different portions of a network (in particular, wired portions of the network versus wireless portions of the network) can have different maximum bandwidths and quality levels, and network conditions can change over time. To accommodate the diversity in client and network characteristics as well as the time-varying nature of network conditions, intermediate network (“mid-network”) nodes or proxies that adapt or transcode the media stream to the client and the network can be situated on the communication path between a source of media content and the client.

Maintaining the security of the media content is another key to successful media streaming. Typically, the media content is encrypted to protect the content against unauthorized access en route. Ideally, the content would remain encrypted between the source and its final destination (e.g., the client). However, preserving end-to-end security presents a challenge to mid-network transcoding, because transcoding an encrypted stream means decrypting the stream, transcoding the decrypted stream, and re-encrypting the result. Thus, each network transcoding node presents a potential security breach.

There are other challenges to streaming media over a network. For example, some data packets transmitted over a network can experience delays along the way, perhaps arriving late at their destination. Also, some data packets may be lost along the way. The effects of late or lost data packets may be exacerbated for video data that are predictively encoded (compressed). Predictive encoding introduces dependencies in the encoded data that improve the amount of compression but can also result in error propagation in the event of data packet loss or late arrival. With predictive encoding, the decoding of a frame of data may rely on the information in another frame. For example, with MPEG (Moving Pictures Experts Group) encoding, a B-frame is predicted from two P-frames or an I-frame and P-frame. Therefore, data packets for the two P-frames or for the P-frame and the I-frame need to be received earlier than their respective display times so that those frames can be used to decode the B-frame. Thus, encoded video frames that do not arrive or that arrive late at the decoder (e.g., a client or destination node) may not only miss their respective display deadlines, but may also prevent a number of other, subsequent frames from being displayed properly, depending on the particular coding dependencies of the late or missing frames. This can affect the overall quality of the display.

Thus, in addition to accommodating diverse client capabilities and heterogeneous and time-varying communication links and in addition to maintaining security of the media content, another key to successful media streaming over a network is reducing the likelihood that packets may be lost or delayed. Conventional solutions are either lacking in one or more of these capabilities, or are unduly complex.

### DISCLOSURE OF THE INVENTION

Embodiments of the present invention pertain to methods and systems thereof for streaming media data. In one embodiment, data in a plurality of data packets is accessed. The data is separated into a plurality of data portions. The data portions are sent to respective nodes in a network, wherein the nodes process (e.g., transcode) the data in parallel with each other.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a network upon which embodiments in accordance with the present invention may be implemented.

FIG. 2 is a block diagram of parallel nodes in a network upon which embodiments in accordance with the present invention may be implemented.

FIG. 3 is a block diagram of serial nodes in a network upon which embodiments in accordance with the present invention may be implemented.

FIG. 4 is a block diagram of serial and parallel nodes in a network upon which embodiments in accordance with the present invention may be implemented.

FIG. 5 diagrams the flow of information into and out of a network node in an embodiment in accordance with the present invention.

FIG. 6 is a block diagram of one embodiment of a transcoder device in accordance with the present invention.

FIG. 7 is a flowchart of a method for transcoding data in serial nodes in accordance with an embodiment of the present invention.

FIG. 8 is a flowchart of a method for transcoding data in parallel nodes in accordance with an embodiment of the present invention.

FIG. 9 is a flowchart of a method for transcoding data in serial and parallel nodes in accordance with an embodiment of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

The descriptions and examples provided herein are discussed in the context of multimedia data (also referred to herein as media data or media content). One example of multimedia data is video data accompanied by audio data; for example, a movie with soundtrack. However, media data can be video only, audio only, or both video and audio. In general, the present invention, in. its various embodiments, is well-suited for use with speech-based data, audio-based data, image-based data, Web page-based data, graphic data and the like, and combinations thereof.

Secure Scalable Streaming and Secure Transcoding

With secure scalable streaming, media data is encoded and encrypted in a manner that allows downstream transcoders to perform transcoding operations by discarding parts of the encrypted and encoded content, without decrypting (and also without decoding) the content.

Secure scalable streaming is based on careful coordination of encoding, encrypting and packetizing operations. As used herein, scalable encoding is defined as a process that takes original data as input and creates scalably encoded data as output, where the scalably encoded data has the property that portions of it can be used to reconstruct the original data with various quality levels. Specifically, the scalably encoded data can be thought of as an embedded bitstream. A portion of the bitstream can be used to decode a baseline-quality reconstruction of the original data, without requiring any information from the remainder of the bitstream, and progressively larger portions of the bitstream can be used to decode improved reconstructions of the original data. For example, if an image is scalably encoded by resolution, then a small portion of the data can be used to decode a low-resolution image, a larger portion of the data can be used to decode a medium-resolution image, and all of the data can be used to decode a full-resolution image. Scalable coding standards include, but are not limited to, MPEG-1/2/4 and H.261/2/3/4, JPEG (Joint Photographic Experts Group) 2000 including Motion JPEG 2000, and 3-D subband coding.

As used herein, progressive encryption is defined as a process that takes original data (plaintext) as input and creates progressively encrypted data (ciphertext) as output. Progressive encryption techniques include, for example, cipher block chains and stream ciphers. These progressive encryption methods have the property that the first portion of the data is encrypted independently, and later portions are encrypted based on earlier portions. The plaintext is encrypted in a beginning-to-end or sequential manner, wherein a first portion of the bitstream is encrypted by itself, a second portion of the bitstream is encrypted using (e.g., in combination with) the first portion (either the encrypted or the unencrypted first portion may be used), and so on. Progressively encrypted data has the property that the first portion can be decrypted alone, without requiring information from the remainder of the original data; and progressively larger portions can be decrypted with this same property, in which decryption can use data from earlier but not later portions of the bitstream. When properly matched with scalable coding and packetization, progressive encryption provides the ability to transcode media data by truncating or discarding data packets without decrypting the media data. Progressive encryption standards include, but are not limited to, the Data Encryption Standard (DES), Triple-DES, and the Advanced Encryption Standard (AES). These encryption primitives can be applied using a number of block-cipher modes including electronic codebook (ECB), cipher block chaining (CBC), cipher-feedback (CFB), output feedback (OFB), and counter (CTR) modes.

Along with progressive encryption, authentication techniques that may be used include, but are not limited to, popular authentication techniques such as message authentication codes (MACs) and digital signatures (DSs). Popular MACs include hash-based MACs such as Hashed Message Authentication Code (HMAC) using the Secure Hash Algorithm-1 (SHA-1) hash, or cipher-based MACs such as AES in CBC mode. Data packets can be independently authenticated so that one or more packets can be discarded without affecting the ability to authenticate other packets. Alternatively, groups of packets can be independently authenticated, so that groups of packets can be discarded without affecting the ability to authenticate other groups of packets. The above cryptographic techniques may be applied using symmetric key techniques or using public/private key techniques.

To achieve effective and efficient secure scalable streaming, the scalably encoded and progressively encrypted data is placed deliberately into data packets in a prioritized manner so that transcoding can be performed by truncating or discarding the packets, without decrypting the data. In one embodiment, the content is encoded into data packets that are progressively encrypted. Associated with each packet is a header that may or may not be encrypted. The header can be encrypted using an encryption technique that is different from that used to encrypt the content data. If the header is encrypted, it can be decrypted without decrypting the data that represents the media content. The header of a packet includes information that identifies, for example, truncation points in the packet. A first truncation point may correspond to, for example, a first bitrate, resolution or quality level, a second truncation point may correspond to a second bitrate, resolution or quality level, and so on. To transcode or adapt the content to achieve the first level, for example, the header information is read and the first truncation point is identified. The packet can then be truncated at the first truncation point, so that data not needed to realize the first resolution or quality or bitrate level is discarded. The truncated packet is then forwarded to its next destination.

Although bitrate, resolution and quality are named in the example above, embodiments in accordance with the present invention are not so limited. The example, and other examples herein, are not intended to limit the breadth and scope of the invention, but rather to illustrate the variety of parameters that exist and that can be used as a basis for transcoding.

It is possible to transcode even when only a portion of the data is available. That is, for example, one portion of the entirety of data associated with a particular instance of content can be transcoded while another portion of that entirety of data is being received or accessed.

As used herein, truncation of a data packet refers generally to the removal of data from some part of the data packet. In one embodiment, the data is arranged in the packet so that data for a first resolution level, for example, is located in a first portion of the packet, data for a second resolution level is located in a second portion of the packet, and data for a third resolution is located in a third portion, where the second portion is located between the first and third portions. The header information identifies the points in the packet that demarcate the first, second and third portions. In this embodiment, if an image is to be reconstructed at, for example, only the first resolution level, then during transcoding the second and third portions can be truncated. That is, the data packet is in essence severed at the first truncation point, removing the second and third portions, leaving a smaller packet consisting of only the first portion (and the header).

In one embodiment, truncation points for a data packet are specified according to an analysis such as a rate-distortion (R-D) analysis, so that the stream of data packets can be compressed to a rate that is R-D optimal or nearly R-D optimal. In another embodiment, the header portions of the data packets contain information that describes the R-D curves generated by the R-D analysis, and the truncation points are derived from further analysis of the R-D curves.

R-D coding can be achieved by generating an R-D plot for each region of a video image, and then operating on all regions at the same slope that generates the desired total bitrate. Nearly optimal transcoding can be achieved at the data packet level by placing the optimal R-D cutoff points for a number of quality levels in the header portions of the data packets. Then, a transcoder can truncate each packet at the appropriate cutoff point; thus, the resulting packets will contain the appropriate number of bits for each region of the image for the desired quality level. The transcoder reads each packet header, and then truncates the packet at the appropriate point. For example, if three (3) regions in an image are encoded into separate packets, then 3 R-D optimal truncation points are identified for each region and their locations placed in the respective packet header. The transcoder can choose to operate at any of the 3 R-D points (or points in between), and then can truncate each packet at the appropriate cutoff point.

In another embodiment, the data is arranged in a data packet so that data for a first resolution level, for example, is placed in multiple portions of the packet, data for a second resolution level is located in other multiple portions of the packet, and data for a third resolution is located in yet other multiple portions of the packet. That is, data segments associated with the first resolution level, data segments associated with the second resolution level, and data segments associated with the third resolution level are interleaved in the packet. In this example, the header information identifies where the data segments that correspond to each resolution level are located in the packet. In this embodiment, if an image is to be reconstructed at, for example, only the first resolution level, then during transcoding the data segments associated with the first resolution level can be extracted from the packet and re-packetized. Alternatively, the data segments associated with the second and third resolution levels can be extracted from the packet and discarded. R-D coding can be achieved by generating an R-D curve for each segment at the same operating point that generates, for example, a desired bitrate. The R-D information is derived from the compressed but unencrypted data, and then included with the encrypted bitstream as “hints” that can be used to transcode the encrypted data without decrypting the data. The hints may or may not be encrypted. Using the R-D information provided by the hints, the data segments that have a lesser impact on the quality of the reconstructed image can be identified. During transcoding, the data segments corresponding to the frames of lesser importance can be dropped or extracted, as described above. Significantly, the transcoding operation is performed without decrypting the media data.

A premise of the discussion in the preceding paragraph is that the segment lengths do not matter—that is, there is not a constraint on bitrate so that, for example, some number of segments can be sent irrespective of their lengths—or the segments are of equal length. If there is a bitrate constraint, then segment lengths may be a factor to consider during transcoding—for example, it may be better to send two shorter segments instead of one longer one, or vice versa. Thus, in one embodiment, segments are ranked according to their relative “utility” (e.g., their importance per bit). In one embodiment, the utility of a segment is measured by the distortion per bit in the segment. That is, the amount of distortion associated with a segment (the amount of distortion that would result if the segment was dropped or discarded) is divided by the number of bits in the segment, and the ratio of distortion per bit provides the utility of the segment. Segments that have relatively higher utilities are forwarded, while segments that have relatively lower utilities can be dropped or discarded if necessary or desirable.

Instead of truncating packets, transcoding can be accomplished by discarding or dropping entire packets. Again, associated with each packet is a header that may or may not be encrypted. If the header is encrypted, it can be decrypted without decrypting the data that represents the media content. A first packet may contain data that, when decoded, is associated with, for example, a first bitrate, resolution or quality level, and a second packet may contain data that, when decoded and combined with the data in the first packet, is associated with a second bitrate, resolution or quality level. The header can include information that identifies which packets are associated with which of the levels. To transcode or adapt the content to achieve the first level, for example, the header information of each packet is read, the first packet is identified as being associated with the first level, and the second packet is identified as being associated with the second level. Accordingly, the first packet is forwarded to its next destination, and the second packet is dropped or discarded.

The header portion may also contain information identifying each data packet by number, for example. Accordingly, a transcoder can eliminate certain data packets from the stream; for example, if every other packet is to be eliminated (e.g., the odd-numbered packets), a transcoder can use the header information to identify the odd-numbered data packets and eliminate those from the stream of data packets.

To summarize, transcoding can include: 1) packet truncation by truncating one or both ends of a packet; 2) packet truncation by discarding a portion or portions of the packet other than an end; and 3) discarding a packet in entirety. Secure scalable streaming allows streaming media systems to achieve the seemingly conflicting properties of mid-network transcoding and end-to-end security. Transcoding of encrypted data can be performed at intermediate, potentially untrusted, network nodes by truncating or discarding packets without decrypting the data. By design, the transcoding device does not require knowledge of the compression technique, the encryption technique, or even the type of media being transcoded.

Secure Transcoding for Non-scalable Data

The discussion above focused on media encoders that are intended to provide scalability. However, embodiments in accordance with the present invention are also applicable to non-scalable encoders. This can be accomplished because media encoders produce compressed bits, but some of the bits will be more important than other bits considering their impact on the quality of the reconstructed (decoded) image. By recognizing the relative importance of some bits versus other bits, and by extension the relative importance of some video frames versus other frames, bits or frames of greater importance can be identified, so that during transcoding the bits or frames of lesser importance can be dropped or discarded.

To illustrate, consider an example in which encoded video data consists only of P-frames after an initial I-frame (e.g., there are no B-frames). Because the encoded video includes only P-frames, a natural prioritization of frames is not suggested. However, by prioritizing the P-frames according to their respective effect on the reconstructed image, if during transcoding it is necessary to eliminate one or more P-frames, then packets associated with lower priority P-frames can be dropped or discarded, while packets associated with higher priority P-frames can be forwarded to their destination.

In one embodiment, R-D information for performing R-D optimized streaming is generated for the video data. The R-D attributes are summarized in a “hint track” associated with the stream of video data. While the video data is encrypted for security, the hint track may not be encrypted. The R-D information in the hint track can be used to transcode the data. Continuing with the example above, instead of treating all of the P-frames identically, certain P-frames can be intelligently selected based on the R-D information in the hint track. That is, those P-frames that have a lesser impact on the quality of the reconstructed image can be identified. It may even be possible to rank the P-frames according to their impact on image quality. During transcoding, the packets corresponding to the P-frames of lesser importance can be dropped. The number of packets/frames that are dropped can depend, for example, on network constraints. Significantly, the transcoding operation is performed without decrypting the media data.

In another embodiment, information about the relative importance of each frame, and correspondingly about the relative importance of each packet, can be included in header information associated with each packet. Data in the data packet is encrypted, while the header information may or may not be encrypted. In a manner similar to that just described, network transcoders can select or discard packets based on their relative importance and on network constraints, without decrypting the media data.

Other Processing of Data

The discussion above pertains to the transcoding of data. Other types of processing can be performed as well. For example, processing can also be used to add redundancy through repetition coding or error correction coding. Adding redundancy may be appropriate, for example, if a network has glossy characteristics, so that it is useful to send some data more robustly to overcome losses in the network, as well as a loss of a network node (e.g., in a peer-to-peer network, a network node may be turned off).

With repetition coding, the same data is sent multiple times to increase the probability that the data will reach its destination. With error correction coding (e.g., forward error correction), specialized inter-packet redundancy (e.g., Reed-Solomon block codes) are added to the data to overcome losses. Error correction approaches may also interleave packets to convert burst errors into isolated errors. In one implementation, for example, each of the data portions A, B and C and a checksum version of the data portions A, B and C are transmitted. Accordingly, even if one of these transmitted components is not received, the components that are received are sufficient for reproducing the data portions A, B and C.

In general, as used herein, “processing” can refer to (but is not limited to): transcoding; adding redundancy; signal enhancement (for images, video, audio, graphics, data, and header data); noise reduction; resolution enhancement; logo insertion; splicing of streams; VCR functionalities (e.g., speedup, slowdown, pausing of streams); merging video and audio streams; ad insertion; personalization of streams; removing objects from streams; foreground/background segmentation of streams; object recognition; face recognition; voice recognition; speech recognition; similarity detection; signal analysis (e.g., image, video, and audio analysis); text analysis; and media search operations.

Processing Using Information about the Data and the Network

The discussion below describes the processing of data according to various embodiments in accordance with the present invention. In these various embodiments, the data may be scalable or non-scalable, scalably encoded or not, encrypted or not encrypted, and combinations thereof, as described above. Transcoding can be performed by selecting or discarding packets, or by truncating packets, as described above.

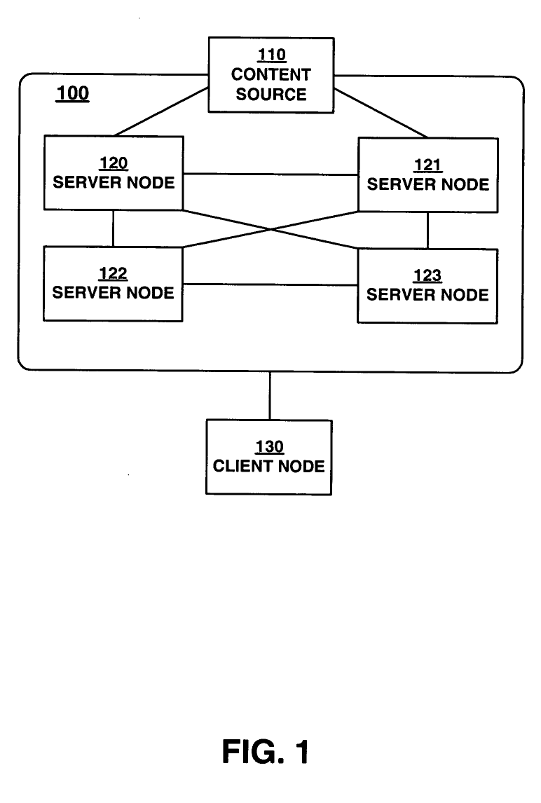

FIG. 1 is a representation of a network 100 upon which embodiments of the present invention may be implemented. In the present embodiment, network 100 includes a content source 110 coupled to a number of interconnected server nodes 120, 121, 122 and 123. There may of course be a greater or lesser number of content sources and server nodes than those illustrated.

The interconnections between these nodes, including content source 110, may be a wired connection, a wireless connection, or a combination thereof. Each interconnection includes one or more channels, so that multiple streaming sessions between nodes can take place in parallel.

Generally speaking, content source 110 and server nodes 120-123 are types of devices that provide the capability to process and/or store data, and to send and receive such data. In particular, in one embodiment, server nodes 120-123 carry out processing operations. In such an embodiment, content source 110 may be a storage device, and server nodes 120-123 may be computer systems as well as other types of devices that may not be typically considered computer systems but have similar capabilities. In another embodiment, content source 110 and server nodes 120-123 carry out processing operations, and as such may be computer systems as well as other types of devices.

In communication with network 100 are client devices such as client node 130, which may be a mobile device or a stationary device. In one embodiment, network 100 is for streaming media data to client node 130. There may of course be multiple client nodes. The client node 130 may be coupled to the network 100 via a wired connection, a wireless connection, or a combination thereof.

In general, network 100 provides the capability to provide data from content source 110, and/or from any of the intermediate server nodes 120-123, to the client node 130. The route, or path, taken by the data as it travels from the content source 110 to the client node 130 may pass through any number of intervening nodes and interconnections between those nodes. Generally speaking, embodiments of the present invention pertain to the streaming of data packets from a sender to a receiver. Any of the nodes in network 100 may be considered to be a sender, and similarly any of the nodes in network 100 may be considered to be a receiver. The sender and receiver nodes may be adjacent nodes, or they may be separated by intervening nodes. Furthermore, in some embodiments, any of the nodes in network 100, including the content source and the client node, can perform the processing of media streams described in conjunction with the figures below. Also, although client node 130 is illustrated as an end node in the network 100, the client node 130 may be a node within the network.

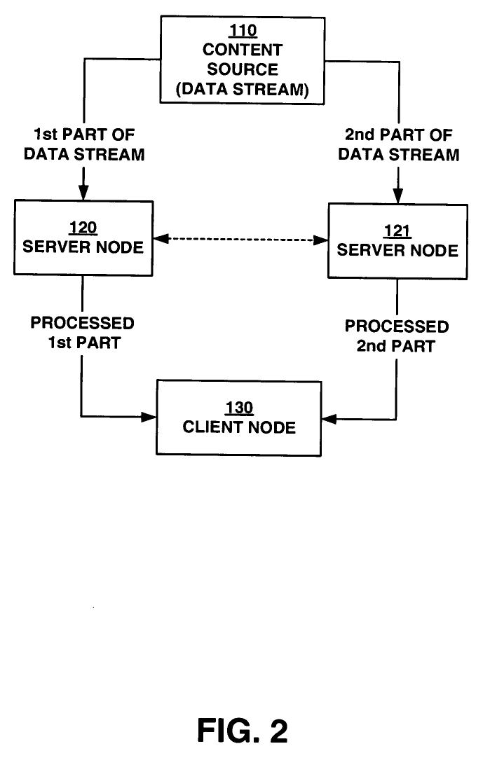

FIG. 2 is a block diagram showing example parallel server nodes 120 and 121 of network 100 (FIG. 1), upon which embodiments in accordance with the present invention may be implemented. In general, server nodes 120 and 121 are network nodes that can perform processing of media streams in parallel. More specifically, server nodes 120 and 121 can independently process different portions of a single stream. That is, in the present embodiment, a first portion of a stream is received at node 120 for processing, and a second portion of the same stream is received at node 121 for processing. In one such embodiment, the data (or data packets) in the first portion and the data (or data packets) in the second portion are mutually exclusive—that is, the data in the first portion is not duplicated in the second portion and vice versa. In other embodiments, the data in the first portion and the data in the second portion overlap each other in part or in entirety.

Although two parallel nodes are described, there may be more than two parallel nodes. Also, although a single stream (separated into two portions) is described, there may be many streams, some or all of which are similarly separated into portions and processed in parallel by server nodes 120 and 121. That is, each of the server nodes 120 and 121 can operate on more than one stream at a time. In essence, server nodes 120 and 121, operating on two parts of the same stream, represent a fundamental case of parallel nodes, which can be extended to situations involving more than two parallel server nodes and more than a single stream per node. Furthermore, there may be one or more intervening nodes situated on the paths from the content source 110 to the server nodes 120 and 121, and there may also be one or more intervening nodes situated on the paths from the server nodes 120 and 121 to the client node 130. Thus, server nodes 120 and 121 may receive streams from an upstream node that is not the content source, and may send streams to a downstream node that is not the client node. Also, server nodes 120 and 121 may receive parts of the same stream from the same upstream node or from different upstream nodes, and may deliver processed streams to the same downstream node or to different downstream nodes.

According to embodiments of the present invention, each of the server nodes 120 and 121 makes processing decisions based at least in part on downstream and/or upstream network conditions respectively measured and observed by the server nodes 120 and 121.

A processing decision may include whether or not to transcode, and the degree to which the data is to be transcoded. The degree to which data is to be transcoded refers, in essence, to the amount of data that is to be discarded (or the amount of data that is to be kept) when transcoding is completed. If, for example, there are 3 levels of resolution represented by the data in a data packet that is to be transcoded, the processing decision involves whether to keep all 3 levels or to discard one (1) or two (2) levels. The processing decision may also result in the data packet being dropped in its entirety.

A processing decision may instead include whether or not to introduce redundancy into the transmitted data. For example, a decision may be made to send the same data, or the same subset of data, to different nodes. Consider data that can be separated into mutually exclusive portions A, B and C. The processing decision may be to send each portion to different nodes, to send portions A and B to one node and portions B and C to another node, or to send portions A, B and C to each of some number of other nodes.

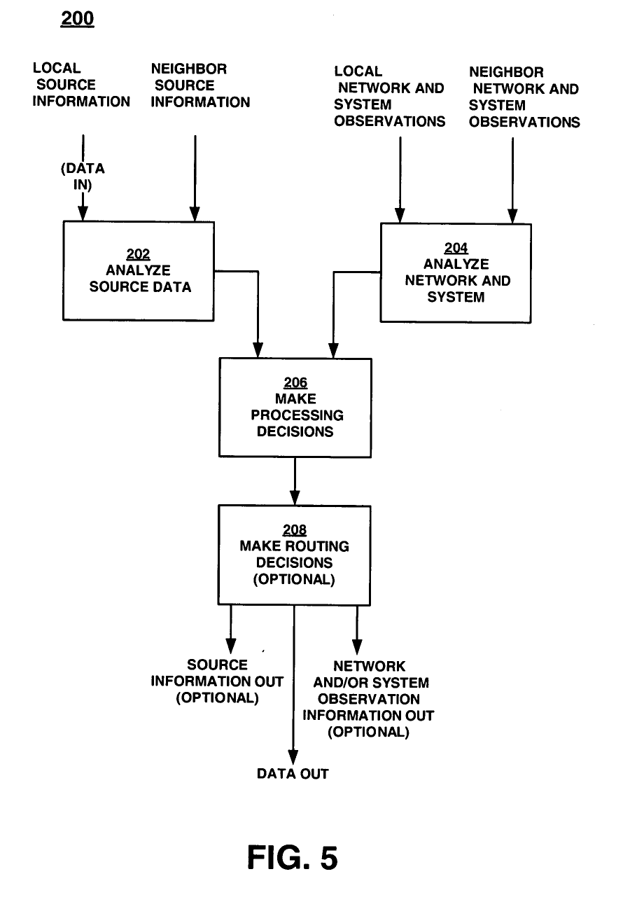

Node 120 can make processing decisions based on the observations and measurements it has made, and node 121 can make processing decisions based on the observations and measurements it has made—that is, nodes 120 and 121 do not necessarily have to share information. Alternatively, server nodes 120 and 121 can share their observations and measurements, and each node can combine the information shared by the other node with its own measurements and observations to make processing decisions. Furthermore, the information shared by nodes 120 and 121 can include information from other nodes that the nodes 120 and 121 are in contact with or have been in contact with. For example, a node downstream or upstream of node 121 can share information with node 121, which can in turn share that information with node 120. The node downstream or upstream of node 121 may have received information from another node (e.g., another parallel node, or a node further downstream or further upstream), and so on. Node 120 can request information from node 121 (a “pull” approach) or node 121 can “push” information to node 120 (and vice versa). Processing decisions can be made based also on information about the data itself. Additional information is provided in conjunction with FIG. 5, below.

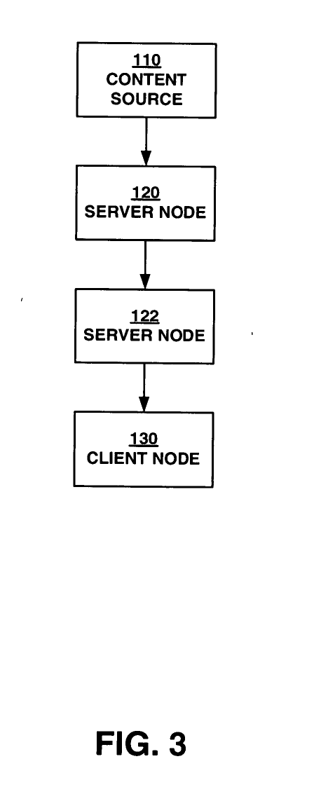

FIG. 3 is a block diagram showing example serial server nodes 120 and 122 of network 100 (FIG. 1), upon which embodiments in accordance with the present invention may be implemented. Nodes 120 and 122 are network nodes that can be used for serial processing of a stream of data. That is, a stream of data is received at server node 120, is processed if processing is warranted, and is forwarded to server node 122 for further processing (if warranted). As above, the server nodes 120 and 122 make processing decisions (e.g., whether or not to transcode, the degree to which the data is to be transcoded, whether or not to introduce redundancy, etc.) based at least in part on network conditions respectively measured and observed by the server nodes 120 and 122, and also based on information about the data itself. Furthermore, server node 122 may share information with server node 120. The information shared by server node 122 may include information that node 122 has received from yet other nodes, in a manner similar to that described above. Additional information is provided in conjunction with FIG. 5, below.

Although FIG. 3 illustrates two serial nodes, there may be more than two serial nodes. Also, although a single stream is described, there may be many streams, each stream processed in parallel by server nodes 120 and 122. That is, each of the server nodes 120 and 122 can operate on more than one stream at a time. In essence, server nodes 120 and 122 represent a fundamental case of serial nodes, which can be extended to situations involving more than two serial server nodes and more than a single stream per node. Furthermore, there may be one or more intervening nodes situated on the paths from the content source 110 to the server node 120, and there may also be one or more intervening nodes situated on the paths from the server node 121 to the client node 130. Thus, server node 120 may receive streams from an upstream node that is not the content source, and server node 121 may send streams to a downstream node that is not the client node.

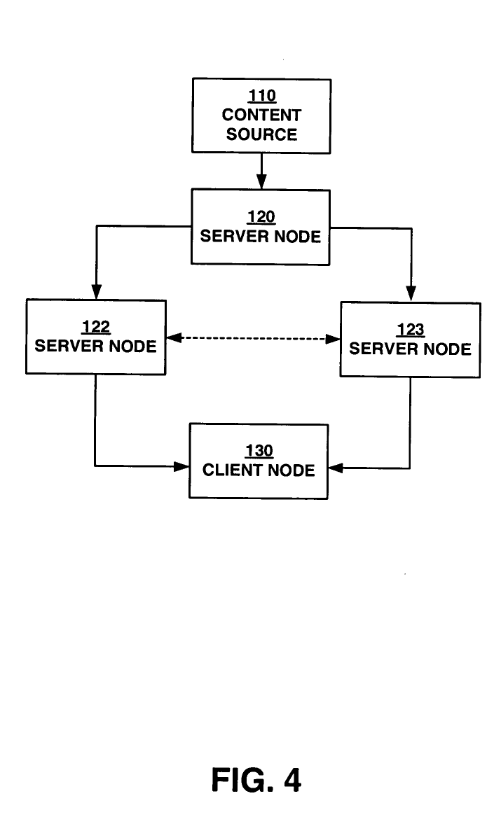

FIG. 4 is a block diagram showing example serial and parallel nodes 120, 122 and 123 of network 100 (FIG. 1), upon which embodiments in accordance with the present invention may be implemented. Nodes 120 and 122, or nodes 120 and 123, are network nodes that can be used for serial processing of a stream of data, as described above in conjunction with FIG. 3. Nodes 122 and 123 can be used for processing parts of a stream in parallel, as described above in conjunction with FIG. 2. As above, the server nodes 120, 122 and 123 make processing decisions (e.g., whether or not to transcode, the degree to which the data is to be transcoded, whether or not to introduce redundancy, etc.) based at least in part on network conditions, and also based on information about the data itself, as described in conjunction with FIGS. 2 and 3 and as described below in conjunction with FIG. 5.

FIG. 5 diagrams the flow of information into and out of a network node 200 in an embodiment in accordance with the present invention. Network node 200 represents any of the network (processing) nodes mentioned above. Network node 200 receives data packets, makes a decision about whether or not to process the packets, makes a decision about the degree of processing to be performed (e.g., whether or not to transcode, the degree to which the data is to be transcoded, whether or not to introduce redundancy, etc.), and outputs data packets (e.g., sends them to the next downstream node, which may be another network node or the client node). In various embodiments, network node 200 makes the processing decision(s) using “local source information,” “neighbor source information,” “local network and system observations” (including measurements), and/or “neighbor network and system observations” (including measurements). Depending on the embodiment, all or only some of this information may be available to the network node 200.

Local source information, as used herein, refers to information about the data that is available to network node 200 from the data packets received by network node 200. For example, local source information can be information carried in, or derived from the information carried in, the header of each data packet received by network node 200. The type of information contained in packet headers has been generally described above. More specifically, local source information can include, but is not limited to, the following types of information: information identifying the beginning and end of data in a data packet; truncation points for truncating data in a data packet; information identifying the length of a data packet; information identifying a transmission time of a data packet; information identifying nominal presentation time for a data packet; information quantifying for a data packet an amount of distortion predicted to occur should the data packet not be sent or received; coding dependencies between a data packet and other data packets; information identifying for a data packet how many other data packets are dependent on the data packet; information identifying whether a data packet provides error resiliency; information identifying whether a data packet provides redundancy; information identifying a deadline for delivering a data packet; information identifying a sequence number for a data packet; prioritization information for a data packet; spatial area features of the data; color component features of the data; resolution levels of the data; quality levels of the data; content of the data; metadata describing the data; security properties of the data; and digital rights management properties of the data. Local source information associated with each particular instance of data (or data packet) is constant for that data; however, data is typically being continually sent and received, and in that respect local source information can change with time. Network node 200 may share its local source information with other nodes.

Local network observations, as used herein, refer to information about the network that is observed or measured by network node 200. More specifically, local network observations can include, but are not limited to, the following types of information for a path in the network immediately downstream of node 200: bandwidth available along the path; bottleneck link capacity along the path; data packet delivery rate; data packet loss rate; data packet received pattern; data packet loss pattern; information identifying which of the data packets were received at the next node along the path; information identifying which of the data packets did not arrive at the next node along the path; information quantifying time needed to traverse the path; and information quantifying delays associated with the path (including latency and jitter, for example). Local network observations can change with time. Network node 200 may share its local network observations with other nodes.

Local system observations, as used herein, refer to information about the network node 200, such as the availability of the node's computational resources, the degree of usage of the node's resources, and the loads on the node's resources. For example, local system observations can include, but are not limited to, system memory usage/availability, system processor usage/availability, system storage usage/availability, and system input/output (I/O) or networking usage/availability. Local system observations can change with time. Network node 200 may share its local system observations with other nodes.

Neighbor source information, as used herein, refers to information that is equivalent in nature to local source information but is received from a neighboring node or nodes. Referring back to FIG. 2, neighbor source information can be received by server node 120 from server node 121, and vice versa. With reference to FIG. 3, server node 120 can receive neighbor source information from server node 122 (because server node 122 is downstream of server node 120, neighbor source information is inherently delivered from server node 120 to server node 122). From the perspective of the local node, neighbor source information can change with time.

Neighbor source information can also include information that describes the processing decision(s) made by a neighboring node. Consider first the case of parallel nodes described in conjunction with FIG. 2, where each of the server nodes 120 and 121 receive packets with data encoded at 3 levels of resolution (low, medium and high). Server node 120, based on its observations of network conditions, may arrive at a decision to transcode the data by truncating the high resolution portions of each data packet (leaving the low and medium portions). Server node 121, based on its local network observations, may arrive at a decision to transcode data by truncating the medium and high resolution portions of each data packet. Therefore, client node 130 has no need for the medium resolution portions of data from server node 120. When server node 121 shares this information with server node 120, then server node 120 can make its transcoding decisions accordingly. In the example above, server node 120 instead arrives at a decision to transcode the data packets by also truncating the medium and high resolution portions of each data packet.

Consider now the case of serial nodes described in conjunction with FIG. 3. Server node 120 may initially send packets to server node 122 with data encoded at 3 levels of resolution. Server node 122, based on its local network observations, may arrive at a decision to transcode data by truncating the high resolution portions of each data packet. Therefore, server node 122 has no further need for the high resolution portions of the data packets being received from server node 120. When server node 122 shares this information with server node 120, then server node 120 can make its transcoding decisions accordingly. In the example above, server node 120 arrives at a decision to begin transcoding the data packets by truncating the high resolution portions of each data packet.

Neighbor network observations and neighbor system observations, as used herein, refer to information that is equivalent in nature to local network observations and local system observations, respectively, but is received from a neighboring node or nodes. Referring back to FIG. 2, neighbor network observations and/or neighbor system observations can be received by server node 120 from server node 121, and vice versa. With reference to FIG. 3, server node 120 can receive neighbor network observations and/or neighbor system observations from server node 122. Neighbor network observations and neighbor system observations can change with time.

With reference to FIG. 5, in block 202, in one embodiment, network node 200 analyzes the local source information and, in another embodiment, the network source information. In block 204, in one embodiment, network node 200 analyzes the local network observations and, in another embodiment, the neighbor network observations. In another embodiment, local system observations are analyzed in block 204. In yet another embodiment, neighbor system observations are analyzed in block 204. Various combinations of the aforementioned types of information can be analyzed by blocks 202 and 204, depending on the availability of such information.

In block 206, based on the analyses in blocks 202 and 204, network node 200 arrives at a decision about whether or not processing is to be performed and, if it is to be performed, the type or degree of processing to be performed. In general, based on the information at hand, network node 200 makes a decision about processing the data on hand. The information at hand generally includes local source information, local network observations, and/or local system observations. In one embodiment, the information at hand also includes neighbor source information, neighbor network observations, and/or neighbor system observations.

In one embodiment, the processing decision also involves a decision as to which of the packets are to be truncated or dropped. In one such embodiment, this decision is made by invoking a “sliding window” scheme. As packets are sent from the processing node, new packets will typically be arriving. Accordingly, a decision about whether or not to process and transmit a particular packet is an evolving decision that can change, depending on what other packets have arrived at the processing node since the initial decision was made. For example, consider a relatively simple example in which five (5) data packets are queued on network node 200. Based on the currently available information about the network, and perhaps as well as the information about the data carried by those 5 packets and the information about the system, a decision is made to transmit the 3 packets having the highest relative priority, as previously described herein. In the meantime, 5 more packets arrive at network node 200 while only 2 of the 3 packets have been sent, so that the queue now contains eight (8) packets. A processing decision about the 8 packets now on hand can be made using updated network and system information as well as information about the data carried by those 8 packets. The decision may be to send another 3 packets, but the 3 packets now selected may not include the packet in the first group of 3 packets that was not sent. In essence, according to one embodiment, a processing decision is made based on a snapshot of the information available to network node 200 at the time the decision is to be made, and a decision affecting the treatment of a packet can be changed (e.g., reversed) at any time. The example above can be extended to instances in which processing includes packet truncation. That is, the example above can be applied to either non-scalable or scalable data.

In one embodiment, in block 208, network node 200 makes a routing decision based on the information at hand (e.g., based on the analyses of local source information, neighbor source information, local system observations, network system observations, local network observations, and/or neighbor network observations from blocks 202 and 204). A routing decision can include a decision about which downstream node or nodes is to receive the outgoing (e.g., processed) data. For example, with reference to FIG. 4, server node 120 can allocate packets to either or both of the parallel server nodes 122 and 123. Routing decisions can also include decisions about which data packets are to be sent to which node. That is, routing decisions can involve not only determining which nodes are to receive data, but how the data is to be distributed amongst those nodes. Furthermore, the routing decision can influence the processing decision. Conversely, the processing decision can influence the routing decision. Moreover, processing and routing decisions made by the downstream nodes can influence the routing decision.

In one embodiment, network node 200 outputs source information (local and/or neighbor). In another embodiment, network node 200 outputs network observation information (local and/or neighbor). In yet another embodiment, network node 200 outputs system observation information (local and/or neighbor).

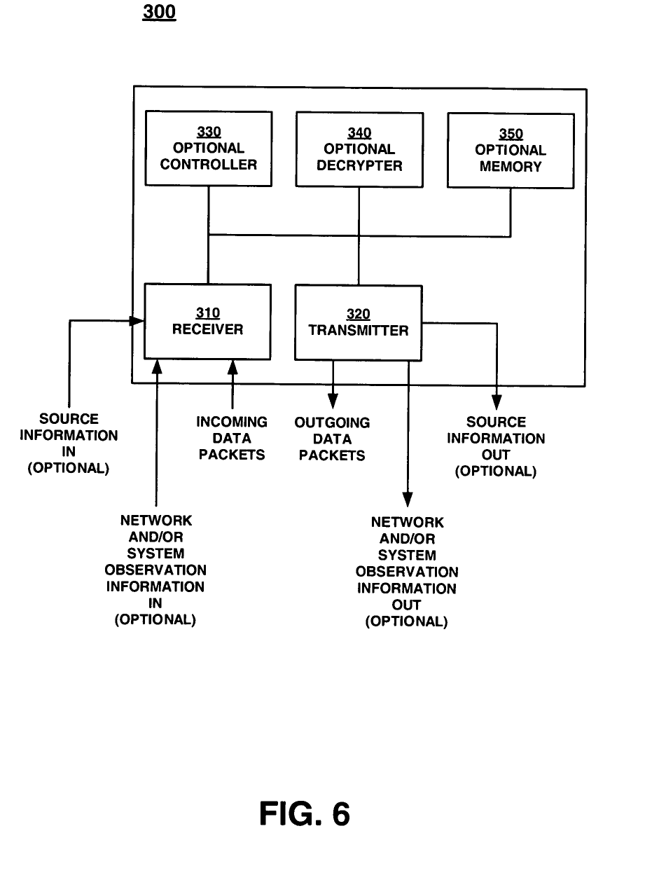

FIG. 6 is a block diagram of one embodiment of a processing device 300 in accordance with the present invention. In this embodiment, processing device 300 includes a receiver 310 and a transmitter 320 for, respectively, receiving a stream of data packets from an upstream node and for sending a stream of data packets to a downstream node. Receiver 310 can also receive source information from another node, network observation information from another node, and/or system observation information from another node. Transmitter 320 can also transmit source information to another node, network observation information to another node, and/or system observation information to another node.

Receiver 310 and transmitter 320 are capable of either wired or wireless communication. Separate receivers and transmitters, one for wired communication and one for wireless communication, may also be used. It is appreciated that receiver 310 and transmitter 320 may be integrated as a single device (e.g., a transceiver).

Processing device 300 may include an optional controller 330 (e.g., a processor or microprocessor), an optional decrypter 340, and an optional memory 350, or a combination thereof. In one embodiment, decrypter 340 is used to decrypt header information. In another embodiment, memory 350 is used to accumulate data packets received from an upstream node before they are forwarded to a downstream node.

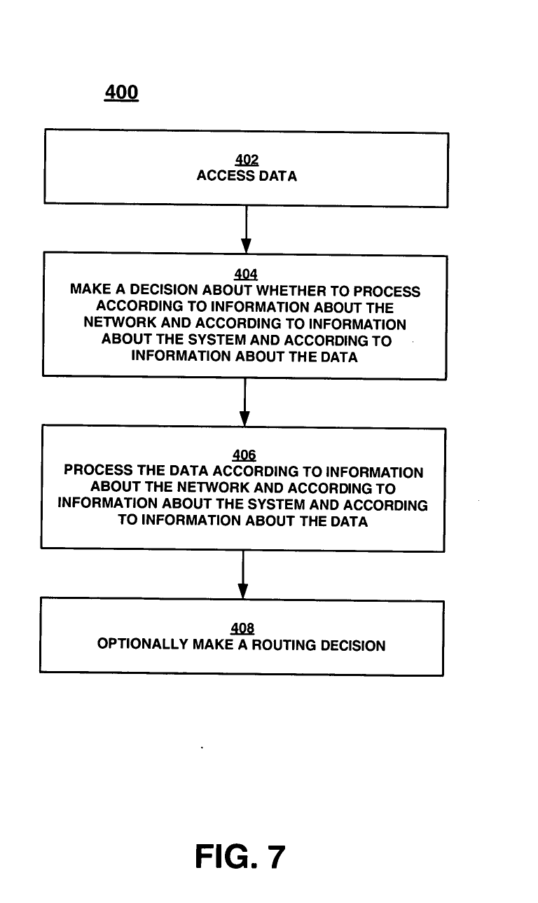

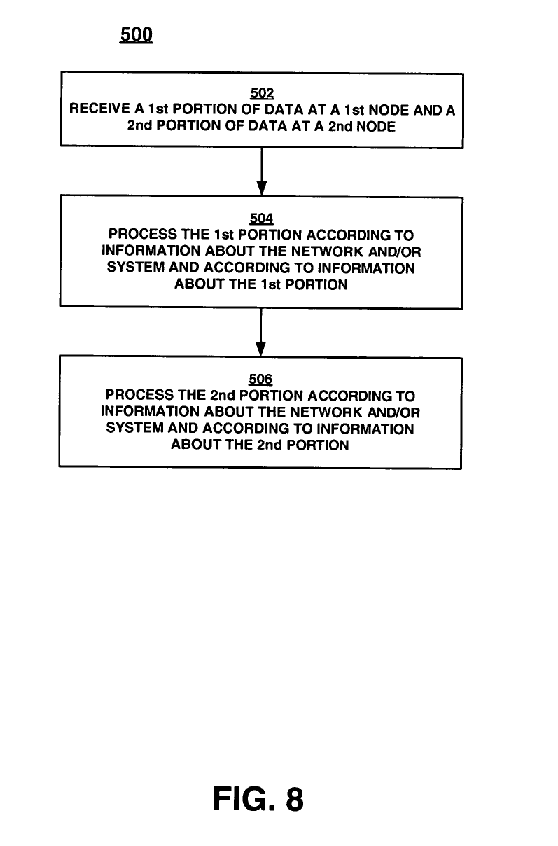

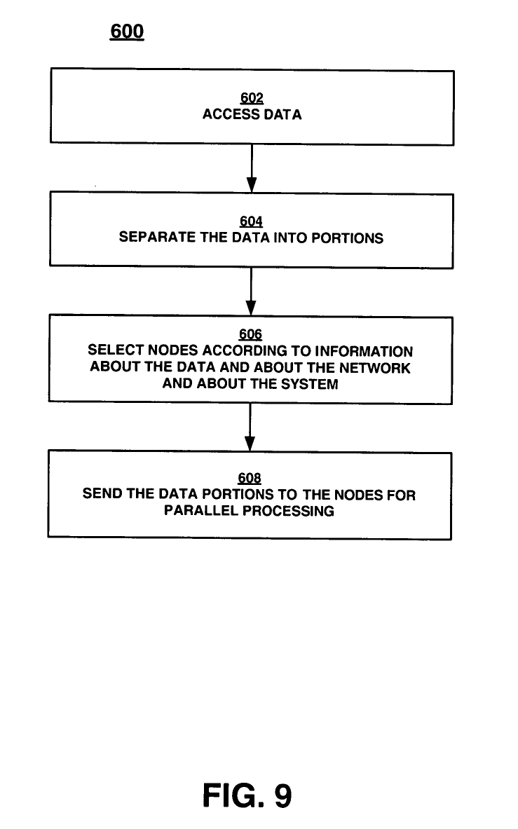

FIG. 7 is a flowchart 400 of a method for serial processing of data in accordance with an embodiment of the present invention. FIG. 8 is a flowchart 500 of a method for parallel processing of data in accordance with an embodiment of the present invention. FIG. 9 is a flowchart 600 of a method for serial and parallel processing data in accordance with an embodiment of the present invention. Although specific steps are disclosed in flowcharts 400, 500 and 600, such steps are exemplary. That is, embodiments of the present invention are well-suited to performing various other steps or variations of the steps recited in flowcharts 400, 500 and 600. It is appreciated that the steps in flowcharts 400, 500 and 600 may be performed in an order different than presented, and that not all of the steps in flowcharts 400, 500 and 600 may be performed. All of, or a portion of, the methods described by flowcharts 400, 500 and 600 may be implemented using computer-readable and computer-executable instructions which reside, for example, in computer-usable media of a computer system.

Generally, flowchart 400 is implemented using serial nodes 120 and 122 of FIG. 3, flowchart 500 is implemented using parallel nodes 120 and 121 of FIG. 2, and flowchart 600 is implemented using the serial and parallel nodes 120, 122 and 123 of FIG. 4.

With reference first to FIG. 7, in block 402, data is accessed. In one embodiment, the data is encoded and packetized. The encoded data may be scalable or non-scalable. In another embodiment, the data is “file-based” (e.g., the data is stored in a file format, streamed from one node to another, and stored as a file on each receiving node). In yet another embodiment, the data is encrypted.

In block 404, a decision is made as to whether or not to process the data, using information about the data, information about the network, and/or information about the system (e.g., node), or a combination thereof. In one embodiment, the information about the data includes local source information, the information about the network includes local network observations, and the information about the system includes local system observations. In another embodiment, the information about the data also includes neighbor source information, the information about the network also includes neighbor network observations, and the information about the system also includes neighbor system observations. The neighbor source information, the neighbor network information, and the neighbor system observations can include information locally observed by the neighbor as well as information that the neighbor has accumulated from its neighbors.

In block 406, if the decision is to process the data, then the data is processed using information about the data, information about the network, and/or information about the system, or a combination thereof. As above, in one embodiment, the information about the data includes local source information, the information about the network includes local network observations, and the information about the system includes local system observations. In another embodiment, similar to the above, the information about the data also includes neighbor source information, the information about the network also includes neighbor network observations, and the information about the system also includes neighbor system observations. Also, as mentioned above, the neighbor source information, the neighbor network information, and the neighbor system information can include information locally observed by the neighbor as well as information that it has accumulated from the neighbor's neighbors.

In block 408, in one embodiment, a routing decision is made using information about the network. Again, in one such embodiment, the information about the network includes local network observations, while in another embodiment, the information about the network also includes neighbor network observations. In another embodiment, a routing decision is made using information about the data. In one such embodiment, the information about the data includes local source information and/or neighbor source information, including not only information locally observed by the neighbor but perhaps including information accumulated from its neighbors. In yet another embodiment, a routing decision can consider neighbor system information.

With reference now to FIG. 8, in block 502, a first portion of data is received at a first node and a second portion of data is received at a second node. In one embodiment, the first portion does not include data that is in the second portion, and vice versa. In another embodiment, the data in the first portion and the data in the second portion may overlap each other in part or in entirety. In one embodiment, the data is encoded and packetized. The encoded data may be scalable or non-scalable. In another embodiment, the data is file-based. In yet another embodiment, the data is encrypted.

In block 504, a decision is made as to whether or not to process the data, as described previously herein. If the decision is to process, then the first portion of data is processed at the first node using information about the first portion of data, information about the network, and/or information about the system (the first node), or a combination thereof. As above, in one embodiment, the information about the first portion of data includes local (first node) source information, the information about the network includes local network observations, and the information about the system includes local system observations. In another embodiment, similar to the above, the information about the first portion of data also includes neighbor source information, the information about the network also includes neighbor network observations, and the information about the system also includes neighbor system observations, including not only information locally observed by the neighbor but perhaps including information accumulated from the neighbor's neighbors. Source, network and system information may or may not be shared between the nodes.

In block 506, if the decision is to process, then the second portion of data is processed at the second node using information about the second portion of data, information about the network, and/or information about the system (the second node), or a combination thereof. As above, in one embodiment, the information about the second portion of data includes local (second node) source information, the information about the network includes local network observations, and the information about the system includes local system observations. In another embodiment, similar to the above, the information about the second portion of data also includes neighbor source information, the information about the network also includes neighbor network observations, and the information about the system also includes neighbor system observations, including not only information locally observed by the neighbor but perhaps including information accumulated from the neighbor's neighbors. Source, system and network information may or may not be shared between the nodes.

With reference now to FIG. 9, in block 602, data is accessed. In one embodiment, the data is encoded and packetized. The encoded data may be scalable or non-scalable. In another embodiment, the data is file-based. In yet another embodiment, the data is encrypted.

In block 604, the data is separated into at least a first portion and a second portion. In one embodiment, the first portion does not include data that is in the second portion, and vice versa.

In block 606, first and second network nodes are identified and selected according to information about the network, information about the data, and/or information about the system, or a combination thereof. In one embodiment, the information about the network includes local network observations, while in another embodiment, the information about the network also includes neighbor network observations, including not only information locally observed by the neighbor but perhaps including information accumulated from the neighbor's neighbors. In one embodiment, the information about the data includes local source information, while in another embodiment, the information about the data also includes neighbor source information, including not only information locally observed by the neighbor but perhaps including information accumulated from the neighbor's neighbors. In one embodiment, the information about the system includes local system observations, while in another embodiment, the information about the system also includes neighbor system observations, including not only information locally observed by the neighbor but perhaps including information accumulated from the neighbor's neighbors.

In block 608, the first portion of data is sent to the first network node for processing, and the second portion of data is sent to the second network node for processing.

In summary, in its various embodiments, the present invention provides methods and systems for streaming media data in a network. The data is processed to accommodate diverse client capabilities. If the data is encrypted, it can be processed without decryption, thereby maintaining the security of the data processing decisions are based on many items of information that capture the nature of the network's heterogeneous and time-varying communication links. The likelihood that packets may be lost or delayed is reduced, by balancing processing operations across server nodes and, in some instances, by conducting processing operations in parallel.

Embodiments of the present invention are thus described. While the present invention has been described in particular embodiments, it should be appreciated that the present invention should not be construed as limited by such embodiments, but rather construed according to the following claims.

What is claimed is:

1. A method of transcoding data, said method comprising:
accessing data comprising a plurality of data packets;
separating said data into a plurality of data portions; and
sending said data portions to respective nodes in a network, wherein said nodes transcodes said data in parallel with each other.

2. The method of claim 1 further comprising selecting said respective nodes according to information about said network.

3. The method of claim 2 further comprising receiving said information about said network from said respective nodes.

4. The method of claim 2 wherein said information about said network is selected from the group consisting of: bandwidth available along a path in said network; bottleneck link capacity along a path in said network; data packet delivery rate; data packet loss rate; data packet received pattern; data packet loss pattern; information identifying which of said data packets were received at a node along said path; information identifying which of said data packets did not arrive at a node along said path; information quantifying time needed to traverse said path; and information quantifying delays associated with said path.

5. The method of claim 1 further comprising selecting said respective nodes according to information about said respective nodes, said information about said respective nodes selected from the group consisting of: node resource usage and node resource availability.

6. The method of claim 1 wherein said network comprises a first node and a second node, said first node transcoding a first data portion of said plurality of data portions according to information about said first data portion and according to information about said network known to said first node, said second node transcoding a second data portion of said plurality of data portions according to information about said second data portion and according to information about said network known to said second node.

7. The method of claim 6 wherein said information about said network known to said first node comprises information observed by said second node and provided to said first node.

8. The method of claim 6 wherein said network further comprises a third node in communication with said first node, wherein said third node sends transcoded data to a downstream node in said network, wherein information about said transcoded data sent from said third node is provided to said first node and wherein said transcoding of said first data portion is also based on said information about said transcoded data sent from said third node.

9. The method of claim 6 further comprising receiving at said first node information about transcoding of said second data portion performed at said second node, wherein said transcoding at said first node is also according to said information about said transcoding of said second data portion.

10. The method of claim 6 further comprising receiving at said first node information about said second node, wherein said transcoding at said first node is also according information about said first node and said information about said second node, said information about said first node and said information about said second node selected from the group consisting of: node resource usage and node resource availability.

11. The method of claim 6 wherein said data is encoded and wherein said information about said first data portion and said information about said second data portion are selected from the group consisting of: information identifying the beginning and end of data in a data packet; header information for a data packet; truncation points for truncating said data; information identifying the length of a data packet; information identifying a transmission time of a data packet; information identifying nominal presentation time for a data packet; information quantifying for a data packet an amount of distortion predicted to occur should said data packet not be sent or received; coding dependencies between a data packet and others of said data packets; information identifying for a data packet how many others of said data packets are dependent on said data packet; information identifying whether a data packet provides error resiliency; information identifying whether a data packet provides redundancy; information identifying a deadline for delivering a data packet; information identifying a sequence number for a data packet; prioritization information for a data packet; spatial area features of said data; color component features of said data; resolution levels of said data; quality levels of said data; content of said data; metadata describing said data; security properties of said data; and digital rights management properties of said data.

12. The method of claim 1 wherein said data is encrypted.

13. In a network comprising a first node, a second node and a third node, a communication path between said first node and said second node and a communication path between said first node and said third node, a system at said first node for transcoding data, said system comprising:
a storage element for storing said data and information about said data; and
a streaming element for sending a respective portion of said data to said second node and another respective portion of said data to said third node, wherein said second and third nodes transcode said respective portions of data in parallel.

14. The system of claim 13 wherein said first node selects said second and third nodes from a plurality of network nodes according to information about said network.

15. The system of claim 14 wherein said first node receives said information about said network from at least said second and third nodes.

16. The system of claim 14 wherein said information about said network is selected from the group consisting of: bandwidth available along a path in said network; bottleneck link capacity along a path in said network; data packet delivery rate; data packet loss rate; data packet received pattern; data packet loss pattern; information identifying which of said data packets were received at a node along said path; information identifying which of said data packets did not arrive at a node along said path; information quantifying time needed to traverse said path; and information quantifying delays associated with said path.

17. The system of claim 13 wherein said first node selects said second and third nodes from a plurality of network nodes according to information about said nodes, said information about said nodes selected from the group consisting of: node resource usage and node resource availability.

18. The system of claim 13 wherein said second node transcodes said respective portion of data according to information about said respective portion of data and according to information about said network known to said second node, and wherein said third node transcodes said another respective portion data according to information about said another respective portion data and according to information about said network known to said third node.

19. The system of claim 17 wherein said information about said network known to said second node comprises information observed by said third node and provided to said second node.

20. The system of claim 17 wherein said network further comprises a fourth node in communication with said second node, wherein said fourth node sends transcoded data to a downstream node in said network, wherein information about said transcoded data sent from said fourth node is provided to said second node and wherein transcoding at said second node is also according to said information about said transcoded data sent from said fourth node.

21. The system of claim 17 wherein said second node receives information about transcoding of said another respective portion of data performed at said third node, wherein transcoding at said second node is also according to said information about said transcoding of said another respective portion of data.

22. The system of claim 13 wherein said data is encoded and packetized and wherein said information about said respective data portions is selected from the group consisting of: information identifying the beginning and end of data in a data packet; header information for a data packet; truncation points for truncating said data; information identifying the length of a data packet; information identifying a transmission time of a data packet; information identifying nominal presentation time for a data packet; information quantifying for a data packet an amount of distortion predicted to occur should said data packet not be sent or received; coding dependencies between a data packet and others of said data packets; information identifying for a data packet how many others of said data packets are dependent on said data packet; information identifying whether a data packet provides error resiliency; information identifying whether a data packet provides redundancy; information identifying a deadline for delivering a data packet; information identifying a sequence number for a data packet; prioritization information for a data packet; spatial area features of said data; color component features of said data; resolution levels of said data; quality levels of said data; content of said data; metadata describing said data; security properties of said data; and digital rights management properties of said data.

23. A network for adaptively streaming data, said network comprising:
a first node;
a second node; and
a third node, wherein said first node and said second node separately communicate with said first node, wherein said first node streams a respective portion of said data to said second node and another respective portion of said data to said third node, wherein said second and third nodes transcode said respective portions of data in parallel with each other.

24. The network of claim 23 wherein said second node comprises a transcoding element for transcoding said respective portion of data according to information descriptive of conditions in said network known to said second node and using information about said respective portion of data, and wherein said third node comprises a transcoding element for transcoding said another respective portion of data according to information descriptive of conditions in said network known to said third node and using information about said another respective portion of data.

25. The network of claim 24 wherein said information about said network known to said second node comprises information observed by said third node and provided to said second node.

26. The network of claim 24 further comprising a fourth node in communication with said second node, wherein said fourth node sends transcoded data to a downstream node in said network, wherein information about said transcoded data sent from said fourth node is provided to said second node and wherein said transcoding of said respective portion of data is also according to said information about said transcoded data sent from said fourth node.

27. The network of claim 24 wherein said second node receives information about transcoding of said another respective portion of data performed at said third node, wherein said transcoding at said second node is also according to said information about said transcoding of said another respective portion of data.

28. The network of claim 23 wherein said first node selects said second and third nodes from a plurality of network nodes according to information about said network known to said first node.

29. The network of claim 28 wherein said first node receives said information about said network from at least said second and third nodes.

30. The network of claim 23 wherein said first node selects said second and third nodes from a plurality of network nodes according to information about said second and third nodes, said information about said second and third nodes selected from the group consisting of: node resource usage and node resource availability.
